(19) United States
(12) Patent Application Publication
(10) Pub. No.: US 2025/0225370 A1
(43) Pub. Date: Jul. 10, 2025

(54) GRAPHICAL MACHINE-LEARNED MODEL EMBEDDING GENERATION AND ENTITY RETRIEVAL

(71) Applicant: Salesforce, Inc., San Francisco, CA (US)

(72) Inventors: Prafulla Kumar Choubey, Palo Alto, CA (US); Chien-Sheng Wu, Palo Alto, CA (US); Regunathan Radhakrishnan, San Francisco, CA (US); Zachary Alexander, San Francisco, CA (US)

(21) Appl. No.: 18/409,641

(22) Filed: Jan. 10, 2024

(51) Int. Cl. G06N 3/045

(52) U.S. Cl. CPC G06N 3/045

(57) ABSTRACT

Predicting the salience of one or more data entities to a particular (target) data entity from among a plurality of data entities may comprise generating a graph of the plurality of data entities and a machine-learned model architecture that predicts the salience of the one or more data entities output by the machine-learned model architecture using the graph. For example, the machine-learned model architecture may comprise a first machine-learned model for generating an embedding using the content of the target data entity, a second machine-learned model for generating a vector using the data type indicated by the target data entity, and a third machine-learned model (e.g., a graph neural network or other feed-forward neural network) for generating a contextual representation of the target data entity to which other contextual representations associated with the plurality of data entities may be compared (e.g., using Euclidean distance, cosine similarity, dot product).

### TECHNICAL FIELD

One or more example implementations relate to the field of machine-learned model inference and training techniques for increasing the accuracy of a machine-learned model architecture.

### BACKGROUND

As data proliferates, it is increasingly difficult to surface information that may be relevant to a user's needs, particularly for situations that demand real-time results. Files accessible to a user may number in the thousands or even trillions and existing search algorithms may require sophisticated familiarity with search tools and the time to comb through results. This may be further complicated by files being different types and located on different hardware and/or across different services.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIGS. 2A and 2B illustrate a pictorial flow diagram of an example process for generating a graph from a relational database that associates different data entities and generating a contextual representation of one of the data entities based at least in part on the graph.

FIG. 3 illustrates a pictorial flow diagram of an example process for determining, based at least in part on the graph, a contextual representation for a data entity by the machine-learned model architecture discussed herein.

FIGS. 4A and 4B illustrate a pictorial flow diagram of an example process for determining one or more data entities that are salient to a query using the machine-learned model architecture discussed herein.

FIG. 5 illustrates a flow diagram of an example process for training the machine-learned model(s) discussed herein.

### DETAILED DESCRIPTION

As the amount of data and services for hosting data grows exponentially, users may spend more time trying to find salient information despite the availability of various search and indexing algorithms. For the average user, taking the time to find salient information might not be overly burdensome, but for users that need to find salient information within a stringent time constraint, such as in seconds or under a minute or two, available software may be insufficient.

The techniques discussed herein may include software and/or hardware that exposes data that is relevant to a user's input to a computing device and/or data provided to the user's computing device. An example of a time-constrained user might be a customer service agent with a customer on the other end of a phone call or chat, someone giving a presentation that's asked a question by an audience member, cybersecurity personnel addressing an emergent threat, or the like. The user might receive data at their computing device, such as a message or audio from a customer or audience member, forensic files, or the like and the techniques discussed herein may include a machine-learned architecture that uses the data received at the computing device and/or further input from the user to determine a salient data entity associated with the data received at the computing device and/or the further user input. As used herein, a data entity may refer to a digital file (e.g., image, document, message, or the like), a portion of a database, a portion of a data structure, and/or the like, although these are given as examples and should not be construed as limiting. Although the techniques and machine-learned models discussed herein may be used in a variety of environments and for a variety of uses, the examples given herein focus on a customer service environment as one of these use cases since it's a use case familiar to many.

For example, deployment of the techniques discussed herein in a customer service hardware environment may enable the computing device of a customer service agent or the customer themselves to determine data entity(ies) that are relevant to an input at the computing device. In some examples, the techniques discussed herein may determine a top k number of data entities that are relevant to the input at the computing device, where k is a positive integer. For example, the techniques may determine the 3, 5, 7, 10, or any other number of data entities that the machine-learned architecture discussed herein predicts to be relevant to the input.

The data at the computing device for which the machine-learned architecture is determining the salient data entity(ies) may be referred to as a query or a query data entity. The query may itself by a data entity. The data entities from which the machine-learned architecture is determining/predicting the most salient data entities may be referred to as keys or key data entities. In a customer service context, the query and/or a key may comprise, for example and without limitation, a message between a customer and a company or customer service agent; a draft message from a customer service agent to a customer; a document such as a knowledge article, contract, warranty, invoice, or the like; a case data structure indicating various data related to an interaction with a customer such as a history of interactions with the customer, customer information, a case comment, case status, case subject matter and/or tags, related product and/or service, a company associated with the case, etc.; a combination of search terms from the customer service agent and any of the other data entities discussed herein, and/or the like. A data entity may comprise content and a data type. For example, an email data entity may include an indication that the data entity is an email type and may include content such as at least the body of the email but the content could additionally or alternatively include the addressees, subject, time sent/received, attachment(s) and/or the like, although in some examples, an attachment may become its own data entity.

In some examples, relations between data entities may indicated in a relational database or other similar sort of database, such as a table. For example, the relational database could indicate that a particular email, a particular case, and a document are related to each other. The email may have been received from a customer, causing the case to be opened (e.g., a case data structure with the attendant information was created responsive to receipt of the email), and the document may comprise a knowledge article that was written as a result of resolving the case for internal reference by customer service agents, a knowledge article that is publicly available that describes a solution or operations related to resolving the case, an attachment to the email, a document associated with a product referenced in the email or resolution of the email, and/or the like.

The techniques discussed herein may comprise generating a graph based at least in part on the relationships between data entities indicated in the relational database. The graph may comprise an undirected graph where a first node/vertex of the graph indicates a first data entity and an edge/link between that first node and a second node indicates that the first data entity is related (as indicated by the relational database) to a second data entity indicated by the second node. Returning to the example given above where the relational database indicates that a case, email, and document are associated (e.g., by occupying a same row in a table or a same portion of the relational database), the case, email, and document may each be represented by nodes in the graph and the graph may include links between each of these nodes.

The techniques described herein may comprise determining a contextual representation of a node of the graph as a function of the neighbors of that node in the graph. A neighbor of a particular (target) node may be defined as being any nodes that are linked directly to the target node in the graph (i.e., link depth of 1). Additionally or alternatively, a neighbor of a particular (target) node may be defined as being any node within n links of the target, where n is a positive integer, e.g., 1, 2, 3, 4, 5, etc. For example, where n is 3, i.e., where the contextual representation is determined for the target node using the neighbor nodes up to a depth of three links, the neighbor nodes of the target node may include a first set of nodes that are directly connected to the target node (depth of 1 link), a second set of nodes that are connected to the first set of nodes (depth of 2 links), and a third set of nodes that are connected to the second set of nodes (depth of 3 links). Note that a set may comprise 0, 1, or more than 1 element.

In some examples, the techniques for determining a contextual representation of a node of the graph may comprise generating, by a first encoder, embedding(s) for the content of the data entity(ies) associated with the target node and its neighbor(s) (if any) and generating, by a second encoder, a vector indicating, according to a learned representation in an embedding space, a type associated with up to each of the data entity(ies). This type vector, once learned by the second encoder, may be stored as a database in association with the different data types. In other words, after the second encoder has been trained, a vector may be generated by the second encoder for each data type and these vectors may be stored in a database and one of these vectors may be retrieved from the database for the data type indicated by a data entity. In additional or alternate examples, the second encoder may generate the vector live, eschewing the database or functioning in addition to the database.

Regardless, once an embedding and vector has been generated for the target node and an embedding and vector has been generated for (each of) the node's neighbor node(s), the techniques may comprise determining an average of the target node's embedding scaled by the target node's vector plus the neighbor node(s)′ embedding(s) scaled by their respective vector(s). This average may then be concatenated to the target node's embedding and provided as input to a feedforward neural network, such as a graph neural network (GNN), that may determine the contextual representation of the target node. In some examples, the GNN's output by comprise an embedding in a same or different embedding space as the embedding space associated with the embeddings generated for the graph nodes and/or a vector/embedding space of the type vectors.

In some examples, a contextual representation may be determined according to the process described above for up to each node in the graph. These contextual representations may accordingly serve as keys for a query, i.e., the embeddings from which the techniques discussed herein may determine the most relevant/salient data entities to a query data entity. In some examples, as data entities are added to the relational database, the techniques may comprise periodically updating the graph with any modifications that have been made to the graph since the last update, generating a new contextual representation for any new nodes that have been added to the graph, and/or updating the contextual representation for a former node based at least in part on the modifications to the graph that relate to the former node. In some examples, the period for updating the graph and generating new and/or update contextual representations may include passage of a time period, detecting that a threshold number of changes have been made to the relational database, upon detecting any change to the relational database, upon receiving a query, upon receiving a first query within a time period (e.g., a first query within the last 24 hours, a first query of an hour of the day), or the like.

The query data entity itself may be encoded as a contextual representation as well. In some examples, generating the contextual representation for the query data entity may comprise only generating, by the first encoder, an embedding based at least in part on the content of the query data entity; scaling such an embedding by a type vector that is generated by the second encoder based at least in part on a data type indicated by the query data entity; or using the query to generate a graph-based contextual representation like the process described above. According to the latter example, the graph may be updated based at least in part on the query if a portion of the relational database that includes the query has just been added responsive to input at a computing device or if such a portion of the graph already exists this portion of the graph may be retrieved. Regardless, either way if the contextual representation for the query is to be graph-based like the keys, a portion of the graph that is within a depth of n links from the graph node associated with the query may be used to generate the contextual representation according to the discussion above that was used for the keys. For example, this may include using a GNN to determine the contextual representation (i.e., final embedding) using an embedding of the query data entity concatenated with an average of the query data entity's embedding scaled by the query data entity's type vector plus the query node neighbor(s)′ embedding(s) scaled by their respective type vector(s). Additionally or alternatively, the query contextual representation may be generated for only those nodes directly linked to the query data entity or within a number of links that is less than n.

In some examples, the techniques may comprise determining a distance in the embedding space between the query contextual representation and the contextual representation of a key data entity. The techniques may determine the nearest k key data entities based on such a distance, where k is a positive integer. The techniques may comprise transmitting the k data entities to the computing device that generated, indicated, or transmitted the query. For example, the k data entities may be transmitted to the computing device, which may displace the k data entities or at least a portion thereof via a user interface of the computing device. Additionally or alternatively, one or more of the k data entities may be provided as input to an additional machine-learned model that may be trained to determine a summary of a data entity or to generate a summary and an email or chat form of the summary. In the latter example, the output of such a machine-learned model may be used to auto-fill a portion of a user interface, such as field for an email or chat draft. Additionally or alternatively, a link or the data entity itself may be attached to an email or chat draft or transmitted to a second computing device automatically or upon authorization received responsive to input at the computing device.

In some examples, the techniques may further comprise training the machine-learned models discussed herein, such as the various encoders and feed-forward neural network by altering one or more parameters (e.g., weight, bias, links) of one or more of the model(s), e.g., the second encoder and/or the GNN, to reduce a loss determined as part of training. Determining such a loss may be based at least in part on adversarial logit pairing and/or logit mixing training. For example, the training may comprise determining a logit by determining a cosine similarity between a contextual representation for a first data entity and a second contextual representation generated for a second data entity and multiplying the cosine similarity by a temperature (e.g., which may be a trained parameter itself or may be a constant for scaling/normalizing the cosine similarity). The training process may identify a data entity as a positive pair with the first data entity if the data entity is within n links of the data entity and may identify all other data entities as negative pairs. The adversarial logit training or logit mixing training may functionally use the positive pairs to move the contextual representation closer to a portion of the embedding space associated with the positive pairs and the negative pairs to move the contextual representation further from a portion of the embedding space associated with the negative pairs. Practically, determining this loss may comprise determining a binary cross entropy and/or categorical cross entropy loss between the logit determined for the contextual representation output by the model and a logit of a positive pairing or negative pairing with the data entity for which the contextual representation was generated.

In some examples, the first encoder for generating an embedding based at least in part on content of a data entity may be pre-trained. In examples where the first encoder has not been pre-trained, the training process may comprise two stages where, in the first stage, the first encoder is trained by determining a pairwise loss between positive pairs of embeddings generated by the first encoder and altering one or more parameters of the first encoder to reduce cosine distance indicated by the pairwise loss. The second stage may then include the process discussed above using the positive and negative pairs.

Additionally or alternatively, since some queries and/or keys may not have any relationships indicated in a relational database, the graph may be augmented with self-referential link(s) where the links generated for a data entity may at least include a link from that data entity to itself. This may enhance the training of the GNN as it may allow the GNN to accurately handle data entities that have no links to other data entities. In such an example, the training process may include removing the links to other data entities for at least a percentage of the data entities (and preserving those data entities self-referential links).

In some examples, the second encoder may comprise a different encoder for each data type, that way each of the different encoders may be trained separately to determine the type vector for a data entity, which may increase the accuracy of the resultant scaling applied to the embedding(s) as part of generating a contextual representation for a data entity.

In some examples, the techniques discussed herein may increase the accuracy of the data entities determined to be relevant to a query and may reduce an amount of time to complete an operation at a computing device that is pending identification of one or more relevant data entity(ies). For example, the operation may comprise sending a message (e.g., which may include adding content to the message, such as text, attachment, links), outputting a sequence of operations to control a device (e.g., executing operations to fix a networking, computing, recording, database, etc. error; executing operations to capture and/or triage), and/or the like. The techniques may accordingly reduce the latency in conducting such an operation after the stimulus for the operation, such as an input at a computing device, a query transmission, and/or the like. Moreover, the techniques may reduce the number of processing cycles and/or computational resources used (and, accordingly the power consumption) of a system that implements the techniques discussed herein.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

### Example Environment

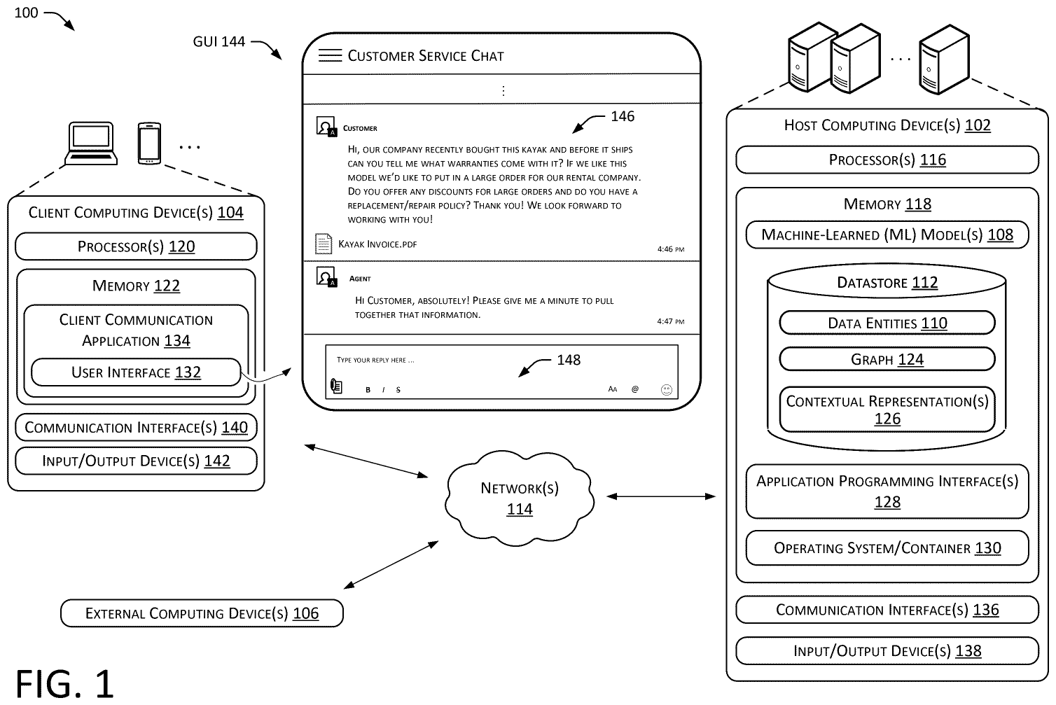

FIG. 1 illustrates an example environment 100 for performing techniques described herein. The techniques and machine-learned models discussed herein may be used in a variety of environments and for a variety of uses, the examples given herein focus on a customer service environment as one of these use cases since it's a use case familiar to many. Although the environment may comprise computing devices used for cybersecurity, presentations, cloud/distributed computing or massive computing efficient data storage and/or retrieval, and/or the like.

In at least one example, the example environment 100 can include one or more computing devices, such as host computing device(s) 102, client computing device(s) 104, and/or external computing device(s) 106. By way of example and not limitation, the host computing device(s) 102 may be representative of servers for hosting the software, hardware, containers, and/or the like to implement at least part of the techniques discussed herein. The computing device(s) 104 may be representative of user computing device(s) associated with a first user (i.e., a first “client device”) and the computing device(s) 106 may be representative of user computing device(s) associated with a second user.

In some examples, the host computing device(s) 102 may store and/or execute the machine-learned model(s) 108 discussed herein for determining data entity(ies) relevant to a query from among data entities 110 stored in a datastore 112 of the host computing device(s) 102. In a customer service example, the first user may include a customer service representative or network/computing administrator and the second user may comprise a customer.

The host computing device(s) 102 may comprise one or more individual servers or other computing devices that may be physically located in a single central location or may be distributed at multiple different locations. The host computing device(s) 102 communication may be hosted privately by an entity administering all or part of the environment 100 (e.g., a utility company, a governmental body, distributor, a retailer, manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures can additionally or alternatively be used.

The computing device(s) 104 and/or 106 may be any suitable type of computing device, e.g., portable, semi-portable, semi-stationary, or stationary. Some examples of such device(s) 104 can include a tablet computing device, a smart phone, a mobile communication device, a laptop, a netbook, a desktop computing device, a terminal computing device, a wearable computing device, an augmented reality device, an Internet of Things (IoT) device, or any other computing device capable of sending communications and performing the functions according to the techniques described herein. In some examples, the client computing device(s) 104 may comprise distributed computing devices, server(s), etc.

In some examples, the host computing device(s) 102, client computing device(s) 104, and/or external computing device(s) 106 may be configured to transmit network packages therebetween via network(s) 114. The network(s) 114 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network, or any other such network, or any combination thereof. The network(s) 114 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the client computing device(s) 104 and/or external computing device(s) 106 may transmit a query to and/receive an output from the machine-learned model 108 or communicate with other user computing device(s) via the communication platform. Components used for such communications can depend at least in part upon the type of network, the environment selected, or both. Further, the network(s) 114 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON objects sent via a Websocket channel. In some embodiments, the protocol is JSON over RPC, JSON over REST/HTTP, and the like.

Each of the computing devices described herein may include one or more processors and/or memory. Specifically, in the illustrated example, host computing device(s) 102 include processor(s) 116 and memory 118 and client computing device(s) 104 processor(s) 120 and memory 122.

By way of example and not limitation, the processor(s) 116 and/or 120 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory 118 and/or 122 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 118 and/or 122 can be used to store any number of software/functional components that are executable by the processor(s) 116 and/or 120, respectively. In many implementations, these functional components comprise instructions or programs that are executable by the processor(s) 116 and/or 120 and that, when executed, specifically configure the processor(s) 116 and/or 120 to perform the actions attributed to the machine-learned model(s) 108, host computing device(s) 102 and/or client computing device(s) 104, according to the discussion herein.

For example, host computing device(s) 102 may comprise a memory 118 storing the machine-learned model(s) 108 discussed herein. The machine-learned model(s) 108 may comprise different encoders that have the same or different architectures and that at least have different parameters as determined according to the training process. For example, an encoder may comprise Ada2, singular value decomposition (SVD), a VGG network, global vectors for word representation (GloVe), Word2Vec, t-distributed stochastic neighbor embedding (t-SNE), or the like. The machine-learned model(s) 108 may additionally or alternatively comprise a neural network, such as a graph neural network (GNN), multi-layer perceptron(s) (MLP(s)), decoder(s), and/or the like.

The machine-learned model(s) may be trained on the training dataset using supervised, semi-supervised, or unsupervised learning. In at least one example, the training dataset used herein may comprise semi-supervised or supervised labels of a message being associated with an event or not. The ML model may be run with the training dataset and produces a result, which is then compared with a target, for each input vector in the training dataset. Based on the result of the comparison and the specific learning algorithm being used, the parameters of the model may be adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's parameters (e.g., weights, biases, temperature). In some examples, the host computing device(s) 102 may train the machine-learned model(s) 108.

Additionally or alternatively, the memory 118 may comprise a portion of memory 118 (e.g., one or more memories or a portion of a single memory) that collectively forms a datastore 112 that stores data entities 110, a graph 124 generated from the data entities 110, and/or contextual representation(s) 126. A data entity may comprise content and a data type that identifies a file format, data structure format, or a portion of a file or data structure (e.g., a field) of the particular data entity. The content may comprise any type of data, such as text, audio, an image, a document file, a data structure, a database, and/or the like. The data entities 110 may differ depending on the environment 100 in which the techniques discussed herein are deployed. In a customer relationship management example, the data entities 110 may comprise things like case(s) (e.g., data structures indicating various data recording interactions with a customer such as messages sent between external computing device(s) 106 and the client computing device(s) 104 and/or host computing device(s) 102, digital interactions of the external computing device(s) 106 with a website hosted by the host computing device(s) 102), a case comment (e.g., a status of a case, data/content added to a case data structure), a message (e.g., chat transcript, email), document(s) (e.g., a knowledge article in the form of a webpage or a document file, a product document, a purchase order, an invoice), and/or other file(s), such as image(s), audio, and/or the like.

In some examples, the graph 124 may be generated from a relational database according to the discussion herein. In some examples, the relational database may be part of the datastore 112 and may be generated and maintained as part of the saving functions in the portion of memory attributable to the datastore 112. In some examples, the machine-learned model(s) 108 may generate the contextual representation(s) 126 and store them in association with the data entities 110 and/or graph 124. For example, the machine-learned model(s) 108 may generate a contextual representation for up to each data entity of the data entities 110 for training and/or for use as a key for determining an output to transmit responsive to receiving a query. Additionally or alternatively, the machine-learned model(s) 108 may generate a contextual representation based at least in part on a query received from the client computing device(s) 104 and/or external computing device(s) 106.

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like).

The memory 118 may additionally or alternatively store application programming interface(s) (API(s) 128) and/or an operating system and/or container 130. The API(s)) 128 may expose back-end functions and/or services hosted by the host computing device(s) 102 to the client computing device(s) 104 and/or external computing device(s) 106 without transferring the functions/services/software to those computing device(s) and/or by accomplishing the functions and/or services at the host computing device(s) 102. As relates to the instant discussion, this may comprise API(s) for receiving a query from the computing device(s) 104 (e.g., as part of an API call) and/or the external computing device(s) 106, such as a data entity (whether a new data entity that hasn't been stored in the datastore 112 yet or an indication of a data identity stored in the datastore 112), and returning a top k most relevant data entities, an indication thereof (e.g., a link to a data entity), data generated by a machine-learned model based at least in part on one of the k data entities, and/or or instructions associated therewith. For example, such instructions may cause a user interface 132 executed by a client communication application 134 to display an actuatable/selectable option to transmit one or more of the k data entities via network(s) 114 (e.g., to the external computing device(s) 106, populate a message (e.g., by auto-filling a portion of the message, pasting a link to one or more of the k data entities, and/or attaching one or more of the k data entities), and/or the like.

The memory 118 may additionally or alternatively an operating system and/or container 130. In some examples, a container may be instantiated by a cloud orchestrator and may run the operating system and may execute one or more instances of the API(s) 128 and/or machine-learned model(s) 108. Calls to the API including a query to identify a top k relevant data entities may be routed to a container that is executing the machine-learned model(s) 108 according to load balancing and/or the like. In an additional or alternate example, the API(s) and/or machine-learned model 108 may run in a virtual machine or natively on the host computing device(s) 102. In at least one example, the operating system can manage the processor(s), memory, hardware, software, etc. of the host computing device(s) 102.

In some examples, the host computing device(s) 102 may further comprise communication interface(s) 136, which can include one or more interfaces and hardware components for enabling communication with various other devices (e.g., the user computing device 104), such as over the network(s) 114 or directly. In some examples, the communication interface(s) 136 can facilitate communication via WebSockets, APIs (e.g., using API calls), Hypertext Transfer Protocols (HTTPs), etc. The host computing device(s) 102 can further be equipped with various input/output devices 138 (e.g., I/O devices). Such I/O devices 138 can include a display, various user interface controls (e.g., buttons, joystick, keyboard, mouse, touch screen, etc.), audio speakers, connection ports and so forth.

In at least one example, the client computing device(s) 104 can include processor(s) 120, memory 122, communication interface(s) 140, and/or input/output device(s) 142. The memory 122 may store and execute a client communication application 134. In some examples, the client communication application 134 may be configured to authenticate a user to access data and/or services hosted by the host computing device(s) 102. The API(s) 128 may filter the data entities 110 accessible as keys for a query depending on permissions granted to a type of user profile that sends the query. In at least one example, a user profile to which a user authenticates can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In some examples, the client communication application 134 may additionally or alternatively comprise instructions executable by one or more processors to provide a user interface 132. For example, the user interface 132 may comprise a graphical user interface (GUI), such as example GUI 144, that the instructions may cause to be displayed via at least one of the input/output device(s) 142. In at least one example, the client communication application 134 can be a mobile application, a web application, a database interface (e.g., such as an application that presents a SQL or other database interface), or a desktop application. For example, a computing device of the one or more computing device(s) 104 and/or external computing device(s) 106 may access the API(s) 128 via a web browser or stand-alone application (either of which may be part of or host the client communication application 134) that communicates via network(s) 114 with API(s) 128.

In the depicted example, the GUI 144 may be displayed as part of a communication-based application. For example, the client communication application 134 may include instructions to display a message drafting interface, a search query interface, or a triage ticket interface upon selection of any of these interface elements. Interaction with any of these interfaces may create an API call that includes data that may be based at least in part on the interaction with the interface, such as creating a query for transmission to the API(s) 128 for processing by the machine-learned model(s) 108 discussed herein. In some examples, a query may be further based at least in part on data received at the client computing device(s) 104.

To give a more tangible example, the GUI 144 is currently displaying messages sent and received between the client computing device(s) 104 and external computing device(s) 106. The messages may include a first message 146 from a customer that includes an invoice pdf for a kayak and text that states “Hi, our company recently bought this kayak and before it ships can you tell me what warranties come with it? If we like this model we′d like to put in a large order for our rental company. Do you offer any discounts for large orders and do you have a replacement/repair policy? Thank you! We look forward to working with you!” Note that the techniques discussed herein may be particularly helpful for a request for information like this where a user may need to search multiple disparate databases for the requisite data and/or files. In some examples, the techniques discussed herein may reduce the amount of time it would take for a user to reply to this message with helpful information, link(s), and/or attachment(s).

The techniques discussed herein may comprise using this message and/or the invoice as part of a query to transmit to the API(s) 128 for processing by the machine-learned model(s) 108 discussed herein. In some examples, the client communication application 134 may create the query, which may comprise a data structure, such as an API call, network packet, or the like. The client communication application 134 may detect data in the message that may be used as part of a query data entity, such as the text in the message and/or the entire pdf or text and/or images from the pdf. Any of this data may be used as a query, as discussed herein. Additionally or alternatively, the client communication application 134 may create a query from text typed into the text box 148 and/or attachments attached thereto. In some examples, the GUI 144 may additionally or alternatively comprise a sub-GUI for a user to create a query, such as by providing a data entity (e.g., a message, draft message, attachment) and/or by indicating a portion of the GUI from which to extra data for creating or identifying a data entity to include as part of the query. In some examples, a machine-learned model executing on the client computing device(s) 104 may determine the number of queries to create based on a preliminary query, such as the message 146. Additionally or alternatively, a machine-learned model executed by the host computing device(s) 102 may determine to create multiple sub-queries from a single query received from the client computing device(s) 104. In such an example, the number, k, of the top k data entities in the response to the query may be increased in comparison to when one query is processed by the machine-learned model(s) 108 for a particular user profile and/or a particular session or the top k data entities may comprise the top q number of data entities determined by the machine-learned model(s) 108 for the different queries (or sub-queries), where q is a positive integer less than k.

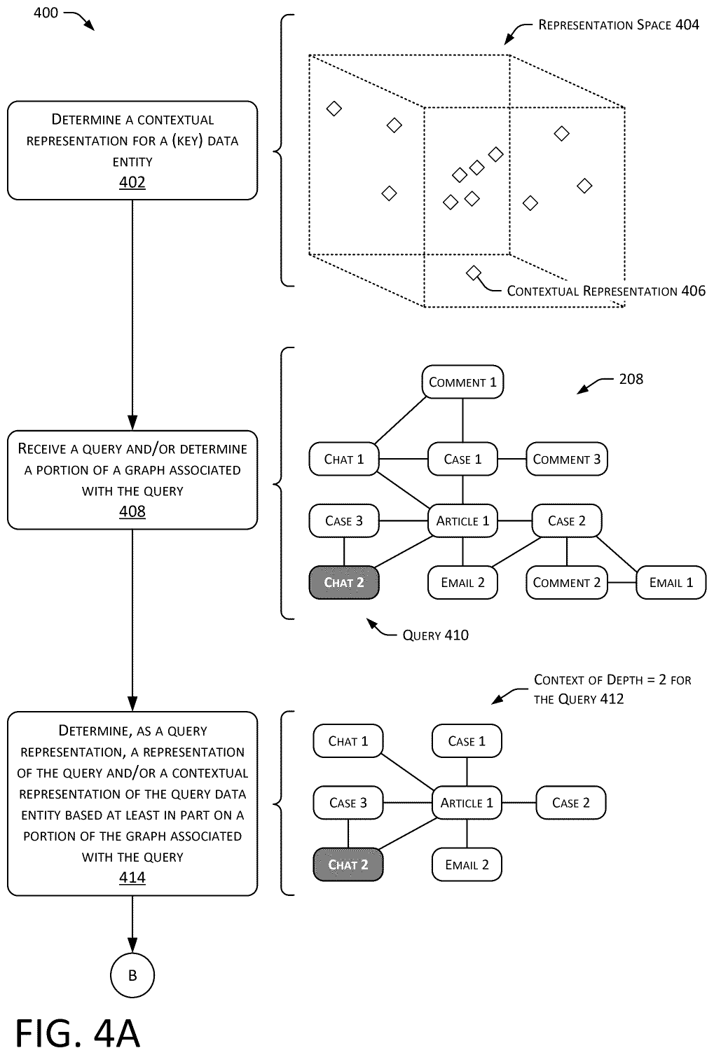

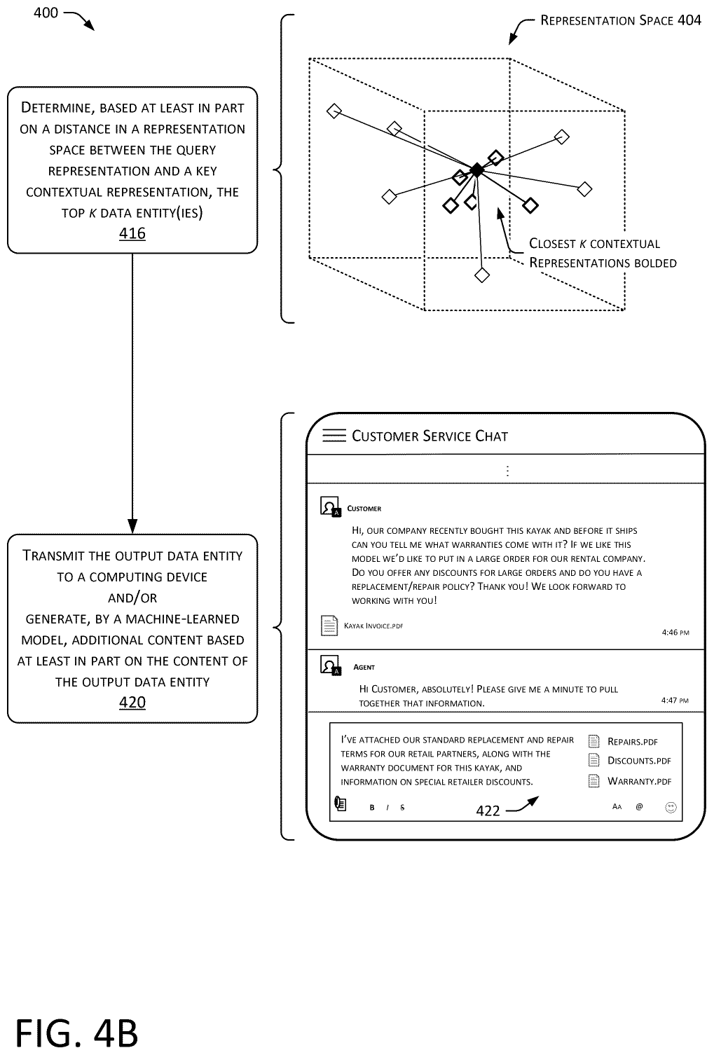

Once the query has been created, the client computing device(s) 104 may transmit the query to the API(s) 128 via the network(s) 114 and communication interface(s) 140. The API(s) 128 may determine whether a user profile identified in association with the query is authenticated for querying the machine-learned model 108 and/or a portion of the datastore 112 that the user profile is authorized to access. So long as the user profile is authenticated and authorized for the access requested, the API(s) 128 may provide the query to the machine-learned model(s) 108 discussed herein. In response, the machine-learned model(s) 108 may determine the top k data entities from among the data entities 110 (or the portion of the data entities 110 that the user profile is authorized to access) and/or one of the machine-learned model(s) 108 may determine a summary, draft message, or the like using the content of one or more of the top k data entities. The top k data entities and/or summary, draft message, or the like may be transmitted, as a response or API response, from the host computing device(s) 102 via network(s) 114 and communication interface(s) 136 to the client computing device(s) 104 or directly to the external computing device(s) 106. An example of such a response and its subsequent use is discussed in further detail in the description of FIG. 4B.

In an additional or alternate example, the external computing device(s) 106 may generate and transmit a query to the host computing device(s) 102, although in some examples, user profiles associated with external computing device(s) 106 may have reduced or at least different permissions in comparison to user profiles associated with the client computing device(s) 104. For example, the portion of the data entities 110 from which an output is determined by the machine-learned model(s) 108 for a query transmitted from the external computing device(s) 106 and a user profile associated therewith may be less or different than the portion of the data entities 110 from which an output is determined for a user profile associated with the client computing device(s) 104.

Example Process for Generating a Graph from a Relational Database and/or Contextual Representation of a Data Entity

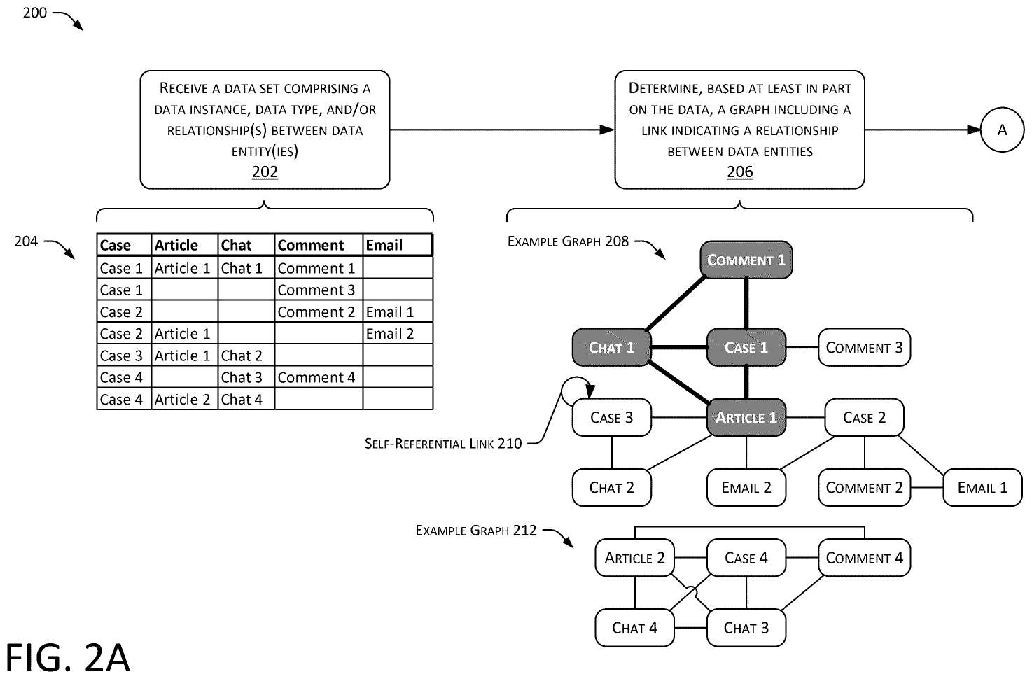

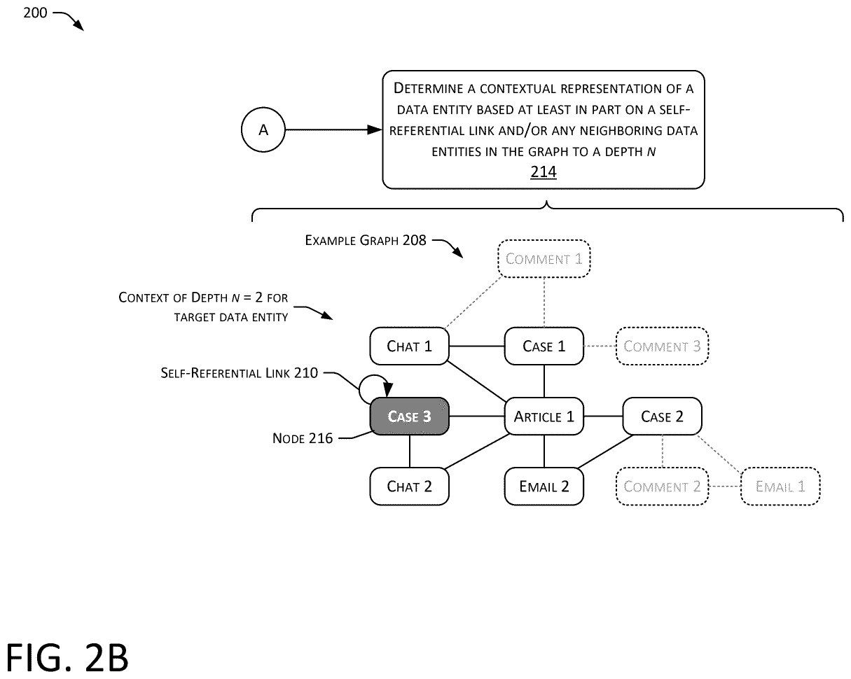

FIGS. 2A and 2B illustrate a pictorial flow diagram of an example process 200 for generating a graph from a relational database that associates different data entities and generating a contextual representation of one of the data entities based at least in part on the graph.

At operation 202, example process 200 can include receiving a data set comprising a data instance, data type, and/or relationship(s) between data entity(ies). For example, the data set may comprise the data entities and a relational database. In some examples, the data entities and/or the relational database may be stored in a datastore. The relational database may identify relationships between data entities and/or the data type associated with a data entity. In some examples, a data entity may additionally or alternatively identify the data type associated with that data entity. FIG. 2A depicts the relational database as a table 204, which is one non-limiting example of a relational database or at least a visual representation of the data structure that is part of the relational database. The data types of the data entities represented in the table 204 include cases, articles, chat transcripts (“chats”), case comments (“comment”), and emails. It is understood that the data entities may be of additional or alternate types, as discussed further above. A data entity indicated by the relational table may have a data type, whether the data entity itself explicitly indicates its own data type or it's indicated in the relational table. A data entity may at least comprise content, such as text, an image, audio, video, a data structure, a portion of a data structure, a file (e.g., webpage, pdf, code), and/or the like.

The table 204 indicates a relationship or association between data entities by storing an indication (e.g., a pointer, link, reference number, or the like) of the related/associated data entities in a same row. For example, the data entities Case 1, Article 1, Chat 1, and Comment 1 are all indicated as being related to each other in the table 204 by virtue of indications of those data entities being included in a same row of the table 204. It is understood that this is a non-limiting way of indicating a relationship between data entities and that other methods may be used, such as comma delimiting; pointer(s) and/or object(s) that identify a location(s) and/or range(s) of memory storing data entities that are related; and/or the like.

At operation 206, example process 200 can include determining, based at least in part on the data set, a graph including a link indicating a relationship between data entities. The graph may comprise an undirected graph where a first node/vertex of the graph indicates a first data entity and an edge/link between that first node and a second node indicates that the first data entity is related (as indicated by the relational database) to a second data entity indicated by the second node. In an additional example, the graph may comprise a directed graph. Returning to the example given above, since table 204 indicates that Case 1, Article 1, Chat 1, and Comment 1 are related by virtue of having indications thereof occupying a same row of the table 204, operation 206 may comprise generating a portion of the graph that includes nodes that indicate the data entities Case 1, Article 1, Chat 1, and Comment 1 and links between these nodes. For example, the example graph 208 depicted in 2A comprises a portion of the graph (indicated by gray-filled nodes and bolded links) that operation 206 may generate using the first row in table 204 that indicates Case 1, Article 1, Chat 1, and Comment 1.

Note that although Article 1, Chat 1, and Comment 1 are indicated as being related to Case 1 by virtue of having indications thereof located in a same row of the relational database, Article 1, Chat 1, and Comment 1 are not explicitly related to Comment 3 even though Comment 3 is indicated as being related to Case 1 in the second row of table 204. Comment 3 could be said to be implicitly associated with Article 1, Chat 1, and Comment 1 by virtue of case type data entities being a hub type entity. In a customer relationship management example, two rows may be created in this fashion for a single case in an example where Case 1 was interacted with during two different time periods (e.g., different days, different hours), by different user profiles, at different points in the case status (e.g., before resolution, at/after escalation, at/after resolution), at different customer interaction points (e.g., new data received from customer such as a new email, updated information, or the like), at different operation points (e.g., before, at, or after action(s) were taken by a computing device, such as granting permissions, changing a hosted service, etc. or were indicated by user input or from an external system as being taken by a system outside the computing device, such as shipping a product or receiving a return), and/or the like.

According to a first example, operation 206 may comprise linking both explicit and implicit relationships, such as by linking Comment 3's node to the nodes of Article 1, Chat 1, and Comment 1 in addition to Case 1's node based on Comment 3's implicit relationship and/or the “case” data type being indicated as being a hub for relationships. A hub entity type may be a special additional data entity type that may be indicated in addition to a data entity's type that allows implicit relationships with that entity type to also be linked for nodes connected to a node of that data entity type. For example, this would result in the node of Comment 3 being linked to the nodes of Comment 1, Chat 1, and Article 1. Although, in a second example and as depicted and discussed throughout, operation 206 may comprise linking nodes for explicit relationships only.

In some examples, operation 206 may further comprise adding a self-referential link to a node for a data entity, such as self-referential link 210. A self-referential link links a data entity to itself, creating a relationship of the data entity to itself. In some examples, a self-referential link may be added to the node of any data entity that has no other links or a self-referential link may be applied to a percentage or all of the nodes. Using these self-referential links may improve the machine-learned model(s) 108 discussed herein by virtue of exposing the machine-learned model(s) 108 during training to nodes that have no links. In other words, without these links the machine-learned model(s) may perform less accurately for a query that has no relationships with other data entities in the relational database.

Further note that the graph need not comprise a contiguous set of connections throughout the graph. For example, the example graph may comprise a first portion that does not comprise any nodes with links to any nodes of a second portion of the graph. FIG. 2A depicts such an example with example graph 212, which is a portion of the graph generated by operation 206 for the last two rows of the table 204 associated with Case 4. Moreover, although the example table 204 includes less than ten rows and the resultant example graph 208 and example graph 212 include in the tens of elements, in practice, the graph may include thousands, hundreds of thousands, millions, or more elements.

Turning to FIG. 2B, at operation 214, example process 200 can include determining a contextual representation of a data entity based at least in part on a self-referential link and/or any neighboring data entities in the graph to a depth of n. In some examples, the contextual representation may be an embedding (e.g., a tensor) that indicates a location in an embedding space, which may have dimension that may be chosen as part of hyperparameters for the machine-learned model(s) discussed herein. In other words, the dimension of the embedding space may be defined by a dimension of the machine-learned model(s)′ output. In some examples, the number of dimensions may be high, such as much more than 3, e.g., 10, 50, 100, 1,000, or more, although in some examples it may be 3 or less.

In some examples, operation 214 may be a preprocessing operation that may be carried out before a query is received and/or periodically. For example, as data entities are added to the relational database, as time passes, or an event is detected, example process 200 may comprise periodically executing operation 206 to update the graph with any modifications that have been made to the graph since the last update, executing operation 206 to generate a new contextual representation for any new nodes that have been added to the graph, and/or executing operation 206 to update the contextual representation for a former node based at least in part on the modifications to the graph that relate to the former node. In some examples, the period for updating the graph and generating new and/or update contextual representations may include passage of a time period, detecting that a threshold number of changes have been made to the relational database, upon detecting any change to the relational database, upon receiving a query, upon receiving a first query within a time period (e.g., a first query within the last 24 hours, a first query of an hour of the day), or the like. In an additional or alternate example, operation 214 may be conducted at inference time responsive to receiving a query, at least for any data entities for which a contextual representation has not yet been determined.

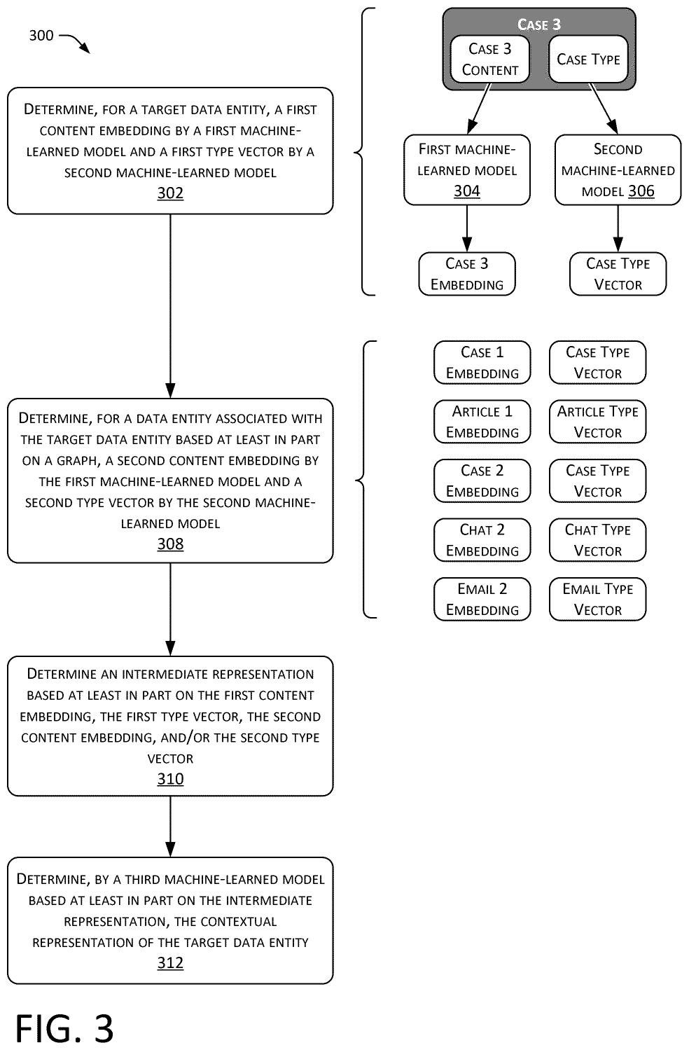

Operation 214 may comprise determining the contextual representation for a (target) data entity as a function of the data entities associated with any neighbor nodes to the target data entity's node in the graph, as discussed in more detail regarding FIG. 3. A node may be indicated to be a neighbor of the target data entity if it is directly linked to the node of the target data entity (i.e., depth of n=1) in the graph or if the node is within n links of the target data entity's node. FIG. 2B includes an example node 216 (shaded gray) that indicates the data entity Case 3 for which operation 214 is to generate a contextual representation, making it the target data entity. In an example where the depth is defined to be two links (i.e., depth n=2), the context/neighbors for generating the contextual representation for the target data entity, Case 3, may include Article 1 and Chat 2 by virtue of their nodes being directly linked to node 216 (i.e., a depth of 1 from the node 216) and Chat 1, Case 1, Case 2, and Email 2 by virtue of their nodes being within two links of node 216 (i.e., a depth of 2 from the node 216). The description of FIG. 3 elaborates how the contextual representation for a data entity may be generated and how it may be a function of the graph context/neighboring data entities, as indicated by the graph.

In some examples, the depth may be a hyperparameter of the process that may be tuned using hyperparameter tuning or may be statically set.

### Example Process for Generating a Contextual Representation

FIG. 3 illustrates a pictorial flow diagram of an example process 300 for determining, based at least in part on the graph, a contextual representation for a data entity by the machine-learned model architecture discussed herein. Example process 300 may be an example of operation 214 and may be executed by at least some of the machine-learned model(s) 108. The depicted example includes determining a contextual representation for Case 3, as depicted in FIGS. 2A and 2B and using example graph 208. Additionally, as an example, the depth has been set to two layers, so the same data entities depicted in FIG. 2B may be used as context for generating the contextual representation for the target data entity, Case 3. As discussed above, example process 300 may be used for any of the data entities stored in the datastore and/or for the query. Note that one of the data entities in the datastore may be used as the query if the data entity is included in the query or otherwise indicated by the query (e.g., responsive to user selection). Any remaining data entities not identified as the query may be used as keys, i.e., those data entities from which the top k data entities relevant to the query may be determined.

At operation 302, example process 300 can include determining, for the target data entity, a first content embedding by a first machine-learned model and a first type vector by a second machine-learned model. As discussed above the target data entity may be the data entity for which the contextual representation is being generated. In some examples, the first machine-learned model may comprise a first encoder and the second machine-learned model may comprise a second encoder. An encoder may comprise an embedding model, such as Ada2, singular value decomposition (SVD), a VGG network, global vectors for word representation (GloVe), Word2Vec, t-distributed stochastic neighbor embedding (t-SNE), a generative pre-trained transformer (GPT) embedding model, the encoding portion of a transformer-based machine-learned model, or the like. The first encoder and the second encoder may comprise a same architecture (e.g., both are GPT architectures, both are VGG architectures) with different parameters or the encoders may have different architectures (e.g., the first encoder includes a GPT architecture and the second encoder includes t-SNE, the first encoder includes a Word2Vec architecture and the second encoder includes GPT architecture).

A data entity may comprise content and a data type. Case 3 includes “Case 3 Content” and the case type (which may be the same for all “cases”). The “Case 3 Content” could include text stating a company's name and contact information, a case identifier, a topic of the case, details of the case, etc. and/or file(s), such as a transaction document, image provided by a user, etc. The first machine-learned model 304 may use the target data entity's content as input (i.e. “Case 3 Content” in this example) to generate an embedding representing the data entity's content in an embedding space. Subsequent discussion refers to this embedding as c₀, the embedding of the target data entity's content.

The second machine-learned model 306 may determine a vector using the data type indicated by the target data entity. Ultimately, this vector may be used to scale the target entity's content embedding and may be the same for all data entities of the same data type. Accordingly, once this vector has been generated for a data type once it may be stored and retrieved. Note that the second machine-learned model 306 may be trained end-to-end with at least the third machine-learned model and, in some instances, end-to-end with both the third machine-learned model and the first machine-learned model (after the first machine-learned model has been trained during a first stage of training). Subsequent discussion refers to this embedding as to, the vector generated for the target data entity's data type.

At operation 308, example process 300 can include determining, for a data entity associated with the target entity based at least in part on the graph, a second content embedding by the first machine-learned model and a second type vector by the second machine-learned model. Operation 308 may be conducted if the target data entity's node in the graph has neighbors (i.e., nodes linked to it within the defined depth) and may otherwise be skipped. In some examples, operation 308 may comprise repeating operation 302 for the content and data type for the neighbor(s) of the node associated with the target data entity in the graph (see discussion of operation 214 regarding FIG. 2B). For the depicted example, Case 3 has five neighbor nodes within two links of node 216. These five neighbors are associated with Case 1, Article 1, Case 2, Chat 2, and Email 2. Accordingly, operation 308 may result in determining a content embedding and type vector for each of these data entities, i.e., Case 1, Article 1, Case 2, Chat 2, and Email 2. Subsequent discussion of the P-th of these neighbor(s) content embeddings and vector embeddings are referred to as cₚ and tₚ, respectively, where P is a positive integer indicating the neighbor of neighbors within n links of the target data entity's node in the graph.

At operation 310, example process 300 can include determining an intermediate representation based at least in part on the first content embedding, the first type vector, and/or the second content embedding and the second type vector. Determining the intermediate representation may comprise determining an average of the target data entity's content embedding scaled by the target data entity's type vector plus the neighbor node(s)′ content embedding(s) scaled by their respective type vector(s). This average may then be concatenated to the target data entity's content embedding as the intermediate representation. For example, the intermediate representation, r, which may itself be an embedding, may be given as:

$$r = {c}_{0} ⊕ \frac{1}{P} {\sum }_{i = 0}^{P} {c}_{i} {t}_{i} \qquad ( 1 )$$

where ⊕ represents the concatenation operation, cₚ is the p-th embedding generated for a data entity's content (and c₀ is the target data entity's content embedding), and tₚ is the p-th vector generated for a data entity's data type (and t₀ is the target data entity's type vector).

At operation 312, example process 300 can include determining, by a third machine-learned model based at least in part on the intermediate representation, the contextual representation of the target data entity. In some examples, the third machine-learned model may comprise a neural network, such as a graph neural network (GNN), multi-layer perceptron(s) (MLP(s)), decoder(s), and/or the like. In at least one example the third machine-learned model is a GNN that receives the intermediate representation as input and determines the contextual representation, as a final embedding that is the contextual representation. In some examples, the final embedding, s, (the contextual representation for the target data entity) may be given as:

$$s = tanh W ( r ) \qquad ( 2 )$$

where W is the feedforward neural network (e.g., a GNN).

In some examples, the contextual representation may be associated with the target data entity's node in the graph. In such an example, the nodes of the graph may indicate both their link(s)/relationship(s) and position in an embedding space such that the graph indicates both spatial and relational data for the data entities, whether they are keys or a query.

Example process 300 may be executed in a same fashion for queries, although in additional or alternate examples, where a query or key does not include linked data entities or a query has been chosen to be made with without graph context, equation (1)'s average may be replaced with the content embedding of the query scaled by the query's type vector.

### Example Process for Generating a Contextual Representation

FIGS. 4A and 4B illustrate a pictorial flow diagram of an example process 400 for determining one or more data entities that are salient to a query using the machine-learned model architecture discussed herein. For example, the machine-learned model architecture may comprise at least a first encoder for generating a content embedding using the content associated with a data entity, a second encoder for generating type vector using the data type associated with the data entity, and a feed-forward neural network for generating a contextual representation of the data entity. In additional or alternate examples, the machine-learned model architecture may comprise a fourth machine-learned model that determines an output based at least in part on content of one or more of the top k data entities determined according to the techniques discussed herein.

At operation 402, example process 400 can include determining a contextual representation for a (key) data entity. A key data entity may be any data entity that is not the query data entity. For example, a key data entity may be a data entity to which the query is to be compared as a candidate to potentially be identified as being relevant to the query data entity. In some examples, operation 402 may be conducted as a pre-processing operation before the query is received, periodically, and/or responsive to detecting an event, such as receiving a new query, detecting a threshold number of additions or modifications to the relational database, and/or the like. In an example where operation 402 is conducted at regular intervals or if a previous query had been received within a time period or without a threshold number of changes being meet yet, operation 402 may comprise determining an updated contextual representation for any nodes that have had a link updated (e.g., removed or added) or data entity content thereof modified and/or operation 402 may comprise determining a new contextual representation for any newly added data entity(ies).

As discussed above, the contextual representations discussed herein may comprise an embedding in a representation space 404 (represented in three dimensions in FIGS. 4A and 4B although the dimensions of the representation space 404 may be less, greater, or significantly greater than three). For the sake of comprehension contextual representations, such as contextual representation 406, are represented as diamonds in a three-dimensional space depicted in FIGS. 4A and 4B. In some examples, the representation space 404 may be a latent space/embedding space. Operation 402 may comprise example process 200 and/or 300, in some examples.

At operation 408, example process 400 can include receiving a query indicating a data entity and/or determining a portion of a graph associated with the query. For example, the data received by the query may have previously existed in the relational database or may be a new data entity, such as a draft message, a newly uploaded file, a message received from a customer, or the like. Additionally or alternatively, the query may indicate a data entity that is already indicated by the relational database. If the query is new, a graph node may be added for the query and any links may be added thereto if any are known. If none are known, a self-referential link may be added to the node generated for the query. For a query that has links to other nodes in the graph, a portion of the graph associated with the query may be determined. In such an example, the portion of the graph determined in association with the query may comprise the neighbors of the query node within the defined depth of links from the query node.

For example, FIG. 4A re-uses the example graph 208 discussed regarding FIGS. 2A-3 and the query 410 is identified as being Chat 2. The portion of the graph determined to be associated with Chat 2 for a depth of two links is indicated at 412. This is the portion of the example graph 208 that may be used to determine a contextual representation for the query at operation 414.

At operation 414, example process 400 can include determining, as a query representation, a representation of the query data entity and/or a contextual representation of the query data representation based at least in part on a portion of the graph associated with the query. For example, operation 414 may comprise example process 200 and/or 300. Where the query has no links with other nodes, the contextual representation generated for the query may be referred to as a query representation and may comprise a content embedding of the query generated by the first encoder using the content of the query or the content embedding of the query scaled by the type vector generated by the second encoder using the data type indicated by the query. In an example where the query indicates a data entity that has already had a contextual representation generated for it, the previous contextual representation generated for that data entity may be retrieved from storage.

Turning to FIG. 4B, at operation 416, example process 400 can include determining, based at least in part on a distance in a representation space between the query representation or query contextual representation and a key contextual representation, the top k data entity(ies) by distance in the representation space to the query representation. In the depicted example, k is 5, the distances determined by operation 416 are depicted as solid lines, and the representation determined for the query is indicated as the solid-filled diamond. Accordingly, operation 416 may result in determining that the contextual representations that are bolded are the top k data entities by virtue of the contextual representations for these five data entities being the five closest data entities to the query contextual representation or query representation. The shorter the distance in the representation space, the more related a key data entity is to the query data entity. Note that k may be any other positive integer and that k=5 is only given as a non-limiting example for comprehension of the techniques. For example, k could be 1, 2, 3, 4, 10, 20, or any other positive integer.

In some examples, although operation 416 is discussed in reference to a distance in Euclidean space for the simplicity of depicting such a concept in the drawings, it is understood that operation 416 may comprise determining a similarity between the query representation/query contextual representation and a key contextual representation by determining a cosine similarity or dot product between the query representation/query contextual representation and a key contextual representation. For example, the cosine similarity between a query representation/contextual representation, a, and a key contextual representation may be determined according to

$$\frac{{a}^{T} b}{\vert a \vert \cdot \vert b \vert}$$

and/or the dot product between the query representation/contextual representation and the key contextual representation may be determined according to |a∥b| cos(θ), where θ is the angle between the query representation/contextual representation and the key contextual representation. If a cosine similarity or dot product is used, the top k data entities may be determined by determining the k data entities for which a greatest cosine similarity or greatest dot product was determined.

As a reminder a query representation may be a latent representation of the query data entity determined by the machine-learned model(s) discussed herein when the query data entity does not include links to other nodes in the graph, whereas a query contextual representation may be a latent representation of the query data entity when the node for the query data entity in the graph is linked to other nodes in the graph.

At operation 420, example process 400 can include transmitting the output data entity (e.g., the top k data entities) to a computing device and/or generating, by a machine-learned model, additional content based at least in part on the content of the output data entity. For example, operation 420 may comprise transmitting link(s) to the top k data entities or the top k data entities themselves to the client computing device(s) 104 or directly to the external computing device(s) 106. In some examples, operation 420 may comprise transmitting sufficient information to preview the content of the top k data entities to facilitate review and/or perusal of the top k data entities by a user. Additionally or alternatively, the user interface at the client computing device(s) 104 may comprise a selectable/activatable user interface element for authorizing transmission of one or more of the top k data entities to the external computing device(s) 106, such as by attaching one or more of the top k data entities to a draft message or the like. Additionally or alternatively, the user interface presented at the client computing device(s) 104 may comprise a selectable user interface element to generate additional content based on a user identified selection (one or more) of the top k data entities. In such an example, an indication of the selected data entities may be transmitted in a request to the host computing device(s) 102. Additionally or alternatively, the request may include user provided selection or other indication of a purpose or instructions for generating the additional content. For example, the user may select one or more of the top k data entities and provide a request to generate a draft message to a customer using content from the selected top k data entities and/or using a message indicated by the user (e.g., such as a message received from the consumer).

In some examples, generating the additional content may comprise using a fourth machine-learned model, such as a decoder, neural network, or transformer-based machine-learned model to generate the additional content using the data indicated in the request. As relates to the data entities selected by the user, this additional content may generated by the machine-learned model be based at least in part on the content of the data entity(ies) indicated in the request.

In an additional or alternate example, the fourth machine-learned model may generate this additional content based at least in part on the top k data entities without receiving a request from the user. In such an example, the user may request an updated version of the additional content based on selection(s) of and/or input from the user (e.g., selecting some of the top k entities to exclude from generating the additional content, instructions to refine the additional content), which may be used by the fourth machine-learned model to regenerate and/or modify the additional content.

FIG. 4B depicts an example of the results of example process 400 for the message exchange originally discussed in FIG. 1, where a customer sent a message with an invoice attachment and the text “Hi, our company recently bought this kayak and before it ships can you tell me what warranties come with it? If we like this model we'd like to put in a large order for our rental company. Do you offer any discounts for large orders and do you have a replacement/repair policy? Thank you! We look forward to working with you!” For such an example, the techniques described herein may determine that three documents, “Repairs.pdf,” “Discounts.pdf,” and “Warranty.pdf”, are in the top k data entities for this message. For the example context of a customer service chat, a user may use the GUI to select which of these three documents to attach to the message or the user may select one of these documents to view or for the fourth machine-learned model to determine a summary thereof or a selection thereof. Additionally or alternatively, the techniques described herein may generate the following draft message 422 as part of the additional content generated by the fourth machine-learned model based on the top k data entities and/or the customer message: “I've attached our standard replacement and repair terms for our retail partners, along with the warranty document for this kayak, and information on special retailer discounts.”

### Example Process for Training the Machine-Learned Model(s)

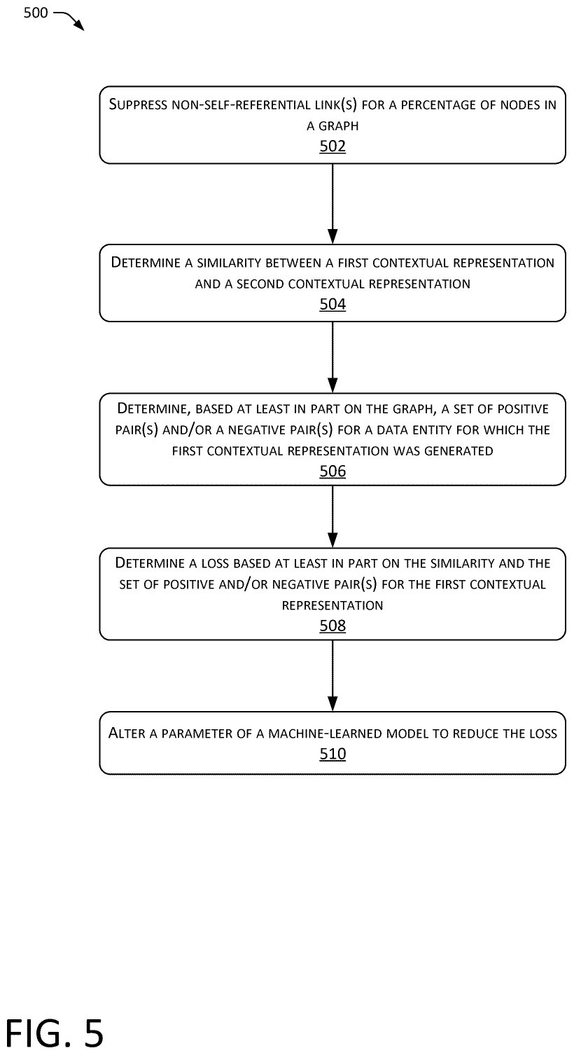

FIG. 5 illustrates a flow diagram of an example process 500 for training the machine-learned model(s) discussed herein. In some examples, example process 500 may be executed by the host computing device(s) 102. In an example where the first encoder for generating an embedding for the content of a data entity is available to be trained (rather than being pre-trained), the training processing may comprise two stages. In the first stage, the first encoder may be trained by determining a pairwise loss between positive pairs of embeddings generated by the first encoder and altering one or more parameters of the first encoder to reduce a distance indicated by the pairwise loss. The second stage may then include the process discussed below using the positive and negative pairs. In some examples, during the second stage, the first encoder's parameters may be fixed (unalterable/unaltered by the loss) or the first encoder's parameters may continue to be refined (e.g., one or more parameter(s) of the first encoder may be altered based on the loss discussed below).

At operation 502, example process 500 can include suppressing non-self-referential link(s) for a percentage of the nodes in the graph. In some examples, operation 502 may occur as a pre-operation before an epoch of training and the particular nodes that make up this percentage may be randomized before each epoch. In other words, after an epoch of training has been completed, the non-self-referential link(s) for this percentage of nodes may be restored and new nodes and/or a new percentage of nodes may be used for the next epoch of training. In some examples, the percentage may decrease with each epoch or may randomly vary. For example, the percentage may at least start at 30%, 40%, 20%, 15%, or the like for the first epoch and may decrease by a set percentage thereafter or may vary from the first epoch's percentage by a set variance.

Operation 502 may be conducted since some queries and/or keys may not have any relationships indicated in a relational database. Accordingly, operation 502 may preserve or add a self-referential link to the percentage of the nodes determined at operation 502. The self-referential link for a node may indicate a link from that data entity for that node to itself. This may enhance the training of the GNN as it may allow the GNN to accurately handle data entities that have no links to other data entities. In such an example, the training process may include removing the links to other data entities for at least a percentage of the data entities (and preserving those data entities self-referential links).

At operation 504, example process 500 can include determining a similarity between a first contextual representation and a second contextual representation. For example, the similarity may be determined based at least in part on a Euclidean distance, a cosine similarity, or a dot product between the representations. In some examples, the similarity may be indicated as a logit. In some examples, operation 504 may additionally or alternatively comprise multiplying the similarity by a temperature, which may be a trained parameter itself or may be a constant for scaling/normalizing the similarity.

At operation 506, example process 500 can include determining, based at least in part on the graph, a set of positive pair(s) and/or negative pair(s) for a target data entity for which the first contextual representation was generated. The training process may identify any data entity(ies) within n links of the target data entity as positive pair(s) with the target data entity and may identify all other data entities as negative pair(s) for the target data entity. In some examples, the training process may comprise adversarial logit training or logit mixing training that may functionally use the positive pairs to move the first contextual representation closer to a portion of the embedding space associated with the positive pairs and may use the negative pairs to move the contextual representation further from a portion of the embedding space associated with the negative pairs.

At operation 508, example process 500 can include determining a loss based at least in part on the similarity and the set of positive and/or negative pair(s) for the first contextual representation. In some examples, determining this loss may comprise determining a binary cross entropy and/or categorical cross entropy loss between the logit determined for the first contextual representation output by the model and a logit of a positive pairing or negative pairing with the data entity for which the contextual representation was generated.

At operation 510, example process 500 can include altering a parameter of a machine-learned model to reduce the loss. For example, operation 510 may comprise altering one or more parameters (e.g., weight, bias, link depth n, temperature) of one or more of the model(s), e.g., the second encoder and/or the GNN, to reduce a loss determined as part of training. In an example where the first encoder is trainable during this stage of the training, operation 510 may additionally or alternatively comprise altering one or more parameters of the first encoder at operation 510. In other words, operation 510 may comprise end-to-end training of any trainable (non-fixed) machine-learned models in the architecture discussed herein. In some examples, operation 510 may comprise altering the one or more parameters according to gradient descent, where the hyperparameters for gradient descent, such as the learning rate, etc. may be set or may be tunable.

In some examples, the second encoder may comprise a different encoder for each data type, that way each of the different encoders may be trained separately to determine the type vector for a data entity, which may increase the accuracy of the resultant scaling applied to the embedding(s) as part of generating a contextual representation for a data entity. In such an example, operation 510 may alter one or more parameters of the particular second encoder associated with the data type indicated by the first contextual representation/target data entity.

### Example Clauses

A. A system comprising: one or more processors; and one or more non-transitory computer-readable media that, when executed by the one or more processors, cause the one or more processors to perform operations comprising: receiving a query indicating first content; generating a query representation based at least in part on a first embedding generated by a first encoder using the first content, the query representation being indicated in an embedding space; receiving a data entity indicating second content and a first data type, the data entity being linked in a graph to a set of data entities; generating, by the first encoder, a second embedding based at least in part on the second content indicated by the data entity; generating, by a second encoder, a vector based at least in part on the first data type indicated by the data entity; generating, by a graph neural network, a contextual representation of the data entity based at least in part on a portion of the graph, the second embedding, and the vector; predicting that the data entity is related to the query based at least in part on determining that the contextual representation is closest to the query representation from among multiple contextual representations associated with other data entities, wherein determining that the contextual representation is closest to the query representation comprises determining a distance between the query representation and the contextual representation in the embedding space; and transmitting an indication of the data entity to a computing device for selection, viewing, auto-filling, or generation of additional content by a machine-learned model based at least in part on the second content.

B. The system of paragraph A, wherein generating the query representation comprises: generating, by the second encoder, a second vector based at least in part on a second data type indicated by the query, wherein the second data type is a same as, or different than, the first data type; and scaling the first embedding by the second vector.

C. The system of either paragraph A or B, wherein: the query further indicates a second data type; the second data type is a same as, or different than, the first data type; and generating the query representation comprises: generating, by the second encoder and based at least in part on the second data type, a second vector; and generating, by the graph neural network, the query representation based at least in part on the graph, the first embedding, and the second vector.

D. The system of any one of paragraphs A-C, wherein generating the contextual representation further comprises: scaling the embedding by the vector as a first intermediate embedding; concatenating, as a concatenated embedding, the embedding with an average of the first intermediate embedding and one or more intermediate embeddings generated for the set of data entities linked to the data entity in the graph; and generating the contextual representation by processing the concatenated embedding by the graph neural network.

E. The system of any one of paragraphs A-D, wherein generating the contextual representation based at least in part on the graph comprises determining the set of data entities linked directly to the data entity in the graph or within n links from the data entity, wherein n is a positive integer.

F. The system of any one of paragraphs A-E, wherein the operations further comprise training at least one of the first encoder, the second encoder, or the graph neural network based at least in part on: determining a cosine similarity between the contextual representation and a second contextual representation generated for a second data entity; determining to indicate that the data entity and the second data entity are a positive pair based at least in part on determining that the data entity and the second data entity are within n links of each other in the graph, wherein n is a positive integer, or determining that the data entity and the second data entity are a negative pair based at least in part on determining that the data entity and the second data entity are disassociated in the graph; determining a loss based at least in part on the cosine similarity and the positive pair indication or the negative pair indication; and altering a parameter of the first encoder, the second encoder, or the graph neural network to reduce the loss.

G. The system of any one of paragraphs A-F, wherein: the graph indicates, via a first link, that the data entity is linked to a second data entity; the graph indicates that the second data entity is linked to itself and, via a second link, to a third data entity; and training at least one of the first encoder, the second encoder, or the graph neural network comprises: removing the second link from the second data entity to the third data entity; indicating the data entity and the second data entity are a positive pair based at least in part on the first link; determining a loss based at least in part on the positive pair indication; and altering a parameter of the first encoder, the second encoder, or the graph neural network to reduce the loss.

H. One or more non transitory computer readable media storing instructions executable by one or more processors, wherein the instructions, when executed, cause the one or more processors to perform operations comprising: receiving a query indicating first content; generating a query representation based at least in part on the query, the query representation being indicated in an embedding space; receiving a data entity indicating second content and a first data type, the data entity being linked in a graph to a set of data entities; generating, by a first machine-learned model, an embedding based at least in part on the second content; generating, by a second machine-learned model, a vector based at least in part on the first data type; generating, by a third machine-learned model, a contextual representation of the data entity based at least in part on a portion of the graph, the embedding, and the vector; and determining, based at least in part on a distance between the query representation and the contextual representation, that the contextual representation is closest to the query representation from among multiple contextual representations associated with other data entities.

I. The one or more non-transitory computer-readable media of paragraph H, wherein generating the query representation comprises: generating, by the first machine-learned model, a second embedding based at least in part on the first content; generating, by the second machine-learned model, a second vector based at least in part on a second data type indicated by the query, wherein the second data type is a same as, or different than, the first data type; and scaling the second embedding by the second vector.

J. The one or more non-transitory computer-readable media of either paragraph H or I, wherein: the query further indicates a second data type; the second data type is a same as, or different than, the first data type; and generating the query representation comprises: generating, by the first machine-learned model and based at least in part on the first content, a second embedding in the embedding space; generating, by the second machine-learned model and based at least in part on the second data type, a second vector; and generating, by the third machine-learned model, the query representation based at least in part on the graph, the second embedding, and the second vector.

K. The one or more non-transitory computer-readable media of any one of paragraphs H-J, wherein generating the contextual representation further comprises: scaling the embedding by the vector as an intermediate embedding; concatenating, as a concatenated embedding, the embedding with an average of the intermediate embedding and one or more intermediate embeddings generated for the set of data entities linked to the data entity in the graph; and generating the contextual representation by processing the concatenated embedding by the third machine-learned model.

L. The one or more non-transitory computer-readable media of any one of paragraphs H-K, wherein generating the contextual representation based at least in part on the graph comprises determining a set of additional data entities that are within n links from the data entity, wherein n is a positive integer and the set of additional entities comprises the set of data entities.

M. The one or more non-transitory computer-readable media of any one of paragraphs H-L, wherein the operations further comprise training at least one of the first machine-learned model, the second machine-learned model, or the third machine-learned model based at least in part on: determining a cosine similarity between the contextual representation and a second contextual representation generated for a second data entity; determining to indicate that the data entity and the second data entity are a positive pair based at least in part on determining that the data entity and the second data entity are within n links of each other in the graph, wherein n is a positive integer, or determining that the data entity and the second data entity are a negative pair based at least in part on determining that the data entity and the second data entity are disassociated in the graph; determining a loss based at least in part on the cosine similarity and the positive pair indication or the negative pair indication; and altering a parameter of the first machine-learned model, the second machine-learned model, or the third machine-learned model to reduce the loss.

N. The one or more non-transitory computer-readable media of any one of paragraphs H-M, wherein: the graph indicates, via a first link, that the data entity is linked to a second data entity; the graph indicates that the second data entity is linked to itself and, via a second link, to a third data entity; and training at least one of the first machine-learned model, the second machine-learned model, or the third machine-learned model comprises: removing the second link from the second data entity to the third data entity; indicating the data entity and the second data entity are a positive pair based at least in part on the first link; determining a loss based at least in part on the positive pair indication; and altering a parameter of the first machine-learned model, the second machine-learned model, or the third machine-learned model to reduce the loss.

O. The one or more non-transitory computer-readable media of any one of paragraphs H-N, wherein the query is received from a user computing device responsive to a selection at a user interface or input provided to the user computing device.

P. The one or more non-transitory computer-readable media of any one of paragraphs H-O, wherein the operations further comprise: generating, by a transformer-based machine-learned model, additional content based at least in part on the second content; and transmitting the additional content to a computing device to at least one auto-fill a portion of a user interface or message with the additional content or attach the second content to the message.

Q. A method comprising: receiving a first data entity indicating first content and a first data type, the data entity being linked in a graph to a set of data entities; generating, by a first machine-learned model, a first embedding based at least in part on the first content; generating, by a second machine-learned model, a vector based at least in part on the first data type; generating, by a third machine-learned model, a contextual representation of the first data entity based at least in part on a portion of the graph, the embedding, and the vector, wherein the contextual representation is indicated in an embedding space; and predicting that the first data entity is related to a second data entity based at least in part on determining a distance between the contextual representation and a second contextual representation associated with a second data entity is within a top n number of smallest distances between the first contextual representation and multiple other contextual representations.

R. The method of paragraph Q, wherein generating the contextual representation further comprises: scaling the first embedding by the vector as an intermediate embedding; concatenating, as a concatenated embedding, the embedding with an average of the intermediate embedding and one or more intermediate embeddings generated for the set of data entities linked to the data entity in the graph; and generating the contextual representation by processing the concatenated embedding by the third machine-learned model.

S. The method of either paragraph Q or R, wherein training at least one of the first machine-learned model, the second machine-learned model, or the third machine-learned model based at least in part on: determining a cosine similarity between the contextual representation and a second contextual representation generated for the second data entity; determining to indicate that the data entity and the second data entity are a positive pair based at least in part on determining that the data entity and the second data entity are within n links of each other in the graph, wherein n is a positive integer, or determining that the data entity and the second data entity are a negative pair based at least in part on determining that the data entity and the second data entity are disassociated in the graph; determining a loss based at least in part on the cosine similarity and the positive pair indication or the negative pair indication; and altering a parameter of the first machine-learned model, the second machine-learned model, or the third machine-learned model to reduce the loss.

T. The method of any one of paragraphs Q-S, wherein the second data entity is received as a query from a user computing device responsive to an input received at the user computing device or a message or file received at the user computing device from another computing device.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. For example, articles such as “a,” “an,” or “the” should be construed as being one or more elements. Moreover, a set should be construed as 0, 1, or more elements, since a set may be an empty set (i.e., a set comprising zero elements), a singleton (i.e., a set comprising a single element), or a set comprising multiple elements (i.e., a set comprising two or more elements). Moreover, it should be appreciated that the term “subset” describes a proper subset. A proper subset of set is a portion of the set that is not equal to the set. For example, if elements A, B, and C belong to a first set, a subset including elements A and B is a proper subset of the first set. However, a subset including elements A, B, and C is not a proper subset of the first set.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types. Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

What is claimed is:

1. A system comprising:
one or more processors; and
one or more non-transitory computer-readable media that, when executed by the one or more processors, cause the one or more processors to perform operations comprising:
receiving a query indicating first content;
generating a query representation based at least in part on a first embedding generated by a first encoder using the first content, the query representation being indicated in an embedding space;
receiving a data entity indicating second content and a first data type, the data entity being linked in a graph to a set of data entities;
generating, by the first encoder, a second embedding based at least in part on the second content indicated by the data entity;
generating, by a second encoder, a vector based at least in part on the first data type indicated by the data entity;
generating, by a graph neural network, a contextual representation of the data entity based at least in part on a portion of the graph, the second embedding, and the vector;
predicting that the data entity is related to the query based at least in part on determining that the contextual representation is closest to the query representation from among multiple contextual representations associated with other data entities, wherein determining that the contextual representation is closest to the query representation comprises determining a distance between the query representation and the contextual representation in the embedding space; and
transmitting an indication of the data entity to a computing device for selection, viewing, auto-filling, or generation of additional content by a machine-learned model based at least in part on the second content.

2. The system of claim 1, wherein generating the query representation comprises:
generating, by the second encoder, a second vector based at least in part on a second data type indicated by the query, wherein the second data type is a same as, or different than, the first data type; and
scaling the first embedding by the second vector.

3. The system of claim 1, wherein:
the query further indicates a second data type;
the second data type is a same as, or different than, the first data type; and
generating the query representation comprises:
generating, by the second encoder and based at least in part on the second data type, a second vector; and
generating, by the graph neural network, the query representation based at least in part on the graph, the first embedding, and the second vector.

4. The system of claim 1, wherein generating the contextual representation further comprises:
scaling the embedding by the vector as a first intermediate embedding;
concatenating, as a concatenated embedding, the embedding with an average of the first intermediate embedding and one or more intermediate embeddings generated for the set of data entities linked to the data entity in the graph; and
generating the contextual representation by processing the concatenated embedding by the graph neural network.

5. The system of claim 1, wherein generating the contextual representation based at least in part on the graph comprises determining the set of data entities linked directly to the data entity in the graph or within n links from the data entity, wherein n is a positive integer.

6. The system of claim 1, wherein the operations further comprise training at least one of the first encoder, the second encoder, or the graph neural network based at least in part on:
determining a cosine similarity between the contextual representation and a second contextual representation generated for a second data entity;
determining to indicate that the data entity and the second data entity are a positive pair based at least in part on determining that the data entity and the second data entity are within n links of each other in the graph, wherein n is a positive integer, or determining that the data entity and the second data entity are a negative pair based at least in part on determining that the data entity and the second data entity are disassociated in the graph;
determining a loss based at least in part on the cosine similarity and the positive pair indication or the negative pair indication; and
altering a parameter of the first encoder, the second encoder, or the graph neural network to reduce the loss.

7. The system of claim 1, wherein:
the graph indicates, via a first link, that the data entity is linked to a second data entity;
the graph indicates that the second data entity is linked to itself and, via a second link, to a third data entity; and
training at least one of the first encoder, the second encoder, or the graph neural network comprises:
removing the second link from the second data entity to the third data entity;
indicating the data entity and the second data entity are a positive pair based at least in part on the first link;
determining a loss based at least in part on the positive pair indication; and
altering a parameter of the first encoder, the second encoder, or the graph neural network to reduce the loss.

8. One or more non-transitory computer-readable media storing instructions executable by one or more processors, wherein the instructions, when executed, cause the one or more processors to perform operations comprising:
receiving a query indicating first content;
generating a query representation based at least in part on the query, the query representation being indicated in an embedding space;
receiving a data entity indicating second content and a first data type, the data entity being linked in a graph to a set of data entities;
generating, by a first machine-learned model, an embedding based at least in part on the second content;
generating, by a second machine-learned model, a vector based at least in part on the first data type;
generating, by a third machine-learned model, a contextual representation of the data entity based at least in part on a portion of the graph, the embedding, and the vector; and
determining, based at least in part on a distance between the query representation and the contextual representation, that the contextual representation is closest to the query representation from among multiple contextual representations associated with other data entities.

9. The one or more non-transitory computer-readable media of claim 8, wherein generating the query representation comprises:
generating, by the first machine-learned model, a second embedding based at least in part on the first content;
generating, by the second machine-learned model, a second vector based at least in part on a second data type indicated by the query, wherein the second data type is a same as, or different than, the first data type; and
scaling the second embedding by the second vector.

10. The one or more non-transitory computer-readable media of claim 8, wherein:
the query further indicates a second data type;
the second data type is a same as, or different than, the first data type; and
generating the query representation comprises:
generating, by the first machine-learned model and based at least in part on the first content, a second embedding in the embedding space;
generating, by the second machine-learned model and based at least in part on the second data type, a second vector; and
generating, by the third machine-learned model, the query representation based at least in part on the graph, the second embedding, and the second vector.

11. The one or more non-transitory computer-readable media of claim 8, wherein generating the contextual representation further comprises:
scaling the embedding by the vector as an intermediate embedding;
concatenating, as a concatenated embedding, the embedding with an average of the intermediate embedding and one or more intermediate embeddings generated for the set of data entities linked to the data entity in the graph; and
generating the contextual representation by processing the concatenated embedding by the third machine-learned model.

12. The one or more non-transitory computer-readable media of claim 8, wherein generating the contextual representation based at least in part on the graph comprises determining a set of additional data entities that are within n links from the data entity, wherein n is a positive integer and the set of additional entities comprises the set of data entities.

13. The one or more non-transitory computer-readable media of claim 8, wherein the operations further comprise training at least one of the first machine-learned model, the second machine-learned model, or the third machine-learned model based at least in part on:
determining a cosine similarity between the contextual representation and a second contextual representation generated for a second data entity;
determining to indicate that the data entity and the second data entity are a positive pair based at least in part on determining that the data entity and the second data entity are within n links of each other in the graph, wherein n is a positive integer, or determining that the data entity and the second data entity are a negative pair based at least in part on determining that the data entity and the second data entity are disassociated in the graph;
determining a loss based at least in part on the cosine similarity and the positive pair indication or the negative pair indication; and
altering a parameter of the first machine-learned model, the second machine-learned model, or the third machine-learned model to reduce the loss.

14. The one or more non-transitory computer-readable media of claim 8, wherein:
the graph indicates, via a first link, that the data entity is linked to a second data entity;
the graph indicates that the second data entity is linked to itself and, via a second link, to a third data entity; and
training at least one of the first machine-learned model, the second machine-learned model, or the third machine-learned model comprises:
removing the second link from the second data entity to the third data entity;
indicating the data entity and the second data entity are a positive pair based at least in part on the first link;
determining a loss based at least in part on the positive pair indication; and
altering a parameter of the first machine-learned model, the second machine-learned model, or the third machine-learned model to reduce the loss.

15. The one or more non-transitory computer-readable media of claim 8, wherein the query is received from a user computing device responsive to a selection at a user interface or input provided to the user computing device.

16. The one or more non-transitory computer-readable media of claim 8, wherein the operations further comprise:
generating, by a transformer-based machine-learned model, additional content based at least in part on the second content; and
transmitting the additional content to a computing device to at least one auto-fill a portion of a user interface or message with the additional content or attach the second content to the message.

17. A method comprising:
receiving a first data entity indicating first content and a first data type, the data entity being linked in a graph to a set of data entities;
generating, by a first machine-learned model, a first embedding based at least in part on the first content;
generating, by a second machine-learned model, a vector based at least in part on the first data type;
generating, by a third machine-learned model, a contextual representation of the first data entity based at least in part on a portion of the graph, the embedding, and the vector, wherein the contextual representation is indicated in an embedding space; and
predicting that the first data entity is related to a second data entity based at least in part on determining a distance between the contextual representation and a second contextual representation associated with a second data entity is within a top n number of smallest distances between the first contextual representation and multiple other contextual representations.

18. The method of claim 17, wherein generating the contextual representation further comprises:
scaling the first embedding by the vector as an intermediate embedding;
concatenating, as a concatenated embedding, the embedding with an average of the intermediate embedding and one or more intermediate embeddings generated for the set of data entities linked to the data entity in the graph; and
generating the contextual representation by processing the concatenated embedding by the third machine-learned model.

19. The method of claim 17, wherein training at least one of the first machine-learned model, the second machine-learned model, or the third machine-learned model based at least in part on:
determining a cosine similarity between the contextual representation and a second contextual representation generated for the second data entity;
determining to indicate that the data entity and the second data entity are a positive pair based at least in part on determining that the data entity and the second data entity are within n links of each other in the graph, wherein n is a positive integer, or determining that the data entity and the second data entity are a negative pair based at least in part on determining that the data entity and the second data entity are disassociated in the graph;
determining a loss based at least in part on the cosine similarity and the positive pair indication or the negative pair indication; and
altering a parameter of the first machine-learned model, the second machine-learned model, or the third machine-learned model to reduce the loss.

20. The method of claim 17, wherein the second data entity is received as a query from a user computing device responsive to an input received at the user computing device or a message or file received at the user computing device from another computing device.
